(19) United States
(12) Patent Application Publication
(10) Pub. No.: US 2015/0034444 A1
(43) Pub. Date: Feb. 5, 2015

(54) REGULATOR DEVICE, AND METHOD PERTAINING TO A REGULATOR DEVICE, FOR CONTROL OF A VISCOUS COUPLING UNIT

(71) Applicant: Scania CV AB, Södertälje (SE)

(72) Inventors: Svante Johansson, Huddinge (SE); Alexander Drexel, Jarna (SE)

(21) Appl. No.: 14/366,781

(22) PCT Filed: Dec. 10, 2012
(86) PCT No.: PCT/SE2012/051363

§ 371 Date: Oct. 22, 2014

(30) Foreign Application Priority Data
Dec. 20, 2011 (SE) 1151225.8

(51) Int. Cl. F16D 35/00

(52) U.S. Cl. CPC F16D 35/005
USPC 192/58.41

(57) ABSTRACT

A regulating device (2) for a viscoclutch (4) which is provided with a primary disc (6) and a secondary disc (8), the primary disc having a first rotation speed (10) and the secondary disc a second rotation speed (12). The regulating device (2) receives signals which represent the rotation speeds and a desired degree of engagement (14), and calculates a prevailing degree of engagement (15) between the discs (10). The degree of engagement between the discs is controlled by regulating an amount of viscous oil between them by delivering a control signal (16) to an oil pump unit (18) which pumps oil (20) into the viscoclutch (4). The nature of the engagement, and controlling for maximum to minimum engagement is disclosed.

### FIELD OF THE INVENTION

The present invention relates to a regulating device and a method in connection with a regulating device, for controlling a viscoclutch according to the preambles of the independent claims. The regulating device and the method are particularly applicable for regulating a viscoclutch associated with a coolant pump

### BACKGROUND TO THE INVENTION

In a cooling system for a vehicle with a combustion engine which has a coolant pump driven via a viscoclutch, it is known that the temperature of the cooling system may be regulated by a control unit by altering the degree of engagement of the viscoclutch. When the cooling requirement increases, the degree of engagement of the viscoclutch will also increase, i.e. the ratio between its output speed and input speed increases. The pump is controlled by means of a viscoclutch which is itself controlled by regulating the flow of viscous oil between two discs, viz. a primary disc driven by an engine belt circuit, and a secondary disc which drives the impeller of the coolant pump. The viscoclutch works in such a way that the more the oil pumped into the working chamber between the discs, the greater the torque transmission, i.e. the greater the degree of engagement. The degree of engagement is for example the ratio between the speeds of the secondary disc and the primary disc.

It is however the case that when the degree of engagement increases, the time taken to pump the viscous liquid out from the working chamber of the viscoclutch will increase and thereby lengthen the time taken to reduce the degree of engagement to a lower value. This greater length of time for disengaging the viscoclutch from high degrees of engagement entails the disadvantage that the coolant pump continues to pump unnecessarily, resulting not only in disadvantageous cooling of the engine but also higher fuel consumption.

A valve is provided to regulate the inflow of viscous oil to the viscoclutch's working chamber. This valve is for example magnetically operated and can assume “open” and “closed” states. The amount of oil supplied is controlled by altering the ratio between the amounts of time when the valve is in these respective states. One such amount might for example be 0.25 second, in which case the valve is controlled at the rate of 4 Hz whereby regulation may be effected by indicating for how much of the time the valve is to be open. The valve being open for the whole amount of time results in maximum flow (100%) and being closed for the whole amount of time results in minimum flow (0%). The valve may be regulated to be able to assume every state between 0 and 100%.

When the valve is open, oil is pumped into the viscoclutch's working chamber and the degree of engagement is thereby controlled. The viscoclutch has on the respective primary and secondary discs a number of circular vanes with oil between them. The oil is pushed outwards in the viscoclutch by centrifugal force and is then caused to flow inwards to a gathering chamber by a pumping action exerted for example by a specially configured vane associated with the outer edge of one of the discs. Thus the greater the degree of engagement of the viscoclutch, the smaller this pumping action, i.e. emptying the viscoclutch of oil will take longer when there is a high degree of engagement.

At full disengagement the viscoclutch will always have a least degree of engagement of for example 20% (at minimum oil supply/oil volume) and a greatest full engagement of about 90% relative to the primary disc (at maximum oil supply/oil volume). Within these limits the extreme states of the viscoclutch are subject to individual variations due to spread of manufacturing tolerances and/or to ageing/wear, which means that the possible regulating range is not known.

The viscoclutch is also able, when regulated close to full engagement, to “jump up ” and become stuck at full engagement. When it is firmly in full engagement or attempts are made to regulate it towards regions beyond its extreme states, the result is problems with integrator upswing. Regulating for example a regulatable coolant pump is extra-sensitive in that it has a narrow regulating range compared for example with a viscoclutch for a fan which runs with higher torque, has a broader regulating range and therefore allows more aggressive regulation. The result when using a viscoclutch in conjunction with a coolant pump is long response times which directly affect fuel consumption when disengaging the pump and cooling performance when engaging it.

Regulating systems for viscoclutches are previously known, e.g. from the patent specifications described below.

US-2003/0133242 refers to a regulating system for controlling a fan which is adapted to cooling a combustion engine and is driven via a viscoclutch. The degree of engagement of the viscoclutch is limited to prevent its exceeding an upper limit and thereby reduce the disengagement times of the viscoclutch.

US-2008/0185254 also refers to a regulating system for controlling a viscoclutch for a fan. Control is conducted inter alia by calculating the difference between desired fan speed and measured fan speed and comparing the difference during different speed states of the fan.

Finally, US-2003/0123995 refers to a viscoclutch connected to a coolant pump for cooling an engine. The degree of engagement of the viscoclutch may be altered inter alia by changing the size of a chamber in the viscoclutch for the viscous oil.

The object of the present invention is to propose a form of control for a viscoclutch which shortens the times taken to disengage the viscoclutch at degrees of engagement which are close to the maximum degree of engagement, and also reduces the risk of so-called integrator upswing. A further object is to improve the control of a viscoclutch at degrees of engagement which are close to the minimum degree of engagement.

A general object of the present invention is to propose an improved form of control for a viscoclutch.

### SUMMARY OF THE INVENTION

The above objects are achieved with the invention defined by the independent claims.

Preferred embodiments are defined by the dependent claims.

In one embodiment of the invention, when a desired degree of engagement is greater than a predetermined high level a control signal is delivered to the pump to work at maximum flow, and once the measured degree of engagement at maximum flow has been substantially constant for a predetermined amount of time, the pumping action is reduced until the degree of engagement is no longer constant, and when the viscoclutch begins to release, i.e. when the degree of engagement decreases, a control signal for maximum flow is delivered again.

To solve the regulating problems, the present invention comprises a set of regulating strategies whereby the regulating range, i.e. the degree of engagement of the viscoclutch, is divided into three regulating regions:
1. A prohibited upper region
2. A permissible region
3. A prohibited lower region

The permissible region is bounded upwards by an upper level and downwards by a lower level.

The prohibited regulating region:

When it receives a demand, i.e. for a desired degree of engagement, within what is deemed to be the prohibited upper region within which the viscoclutch cannot be regulated without risk of so-called integrator upswing, the regulating device switches to a first regulating strategy. If the viscoclutch is given a full control signal, the pump will be fully engaged, causing the viscoclutch to become superfluously full of oil and resulting in unnecessarily long disengagement times, as discussed above. When the maximum engagement of the viscoclutch is not known or the control signal which exactly fully engages the viscoclutch is not known, the degree of engagement of the viscoclutch is monitored. This may be done by determining the ratio between the rotation speeds of the secondary disc and the primary disc, and when this ratio (the degree of engagement) has been constant for a predetermined amount of time the degree of engagement is regarded as having stabilised. This is achieved by the pump first being given a full control signal to quickly reach full engagement. When the degree of engagement of the viscoclutch has then stabilised, the oil supply is throttled, e.g. to the latest control signal within the permissible regulating region. When thereafter the degree of engagement indicates that the viscoclutch is again about to disengage, a full control signal is again delivered until the degree of engagement has again stabilised at full engagement. This prevents the chamber from becoming full of superfluous oil and thereby results in a shorter response time for disengagement. Disengaging the viscoclutch involves first throttling the whole oil supply until the clutch is disengaged before the regulating device begins to act.

According to the invention, the oil level in the viscoclutch is thus regulated so as to be just sufficient to reach the desired high engagement level.

The prohibited lower regulating region:

When it receives a demand for a desired degree of engagement within what is deemed to be the prohibited lower region (below the extreme state of the viscoclutch), which the viscoclutch cannot be regulated to without risk of integrator upswing, the regulating device switches to a logic for full engagement by applying a second regulating strategy. The possible degree of disengagement (least degree of engagement) of the viscoclutch varies because it depends for example on the working temperature of the visco oil, the rotation speed of the primary disc and on manufacturing tolerances and ageing. The method according to the invention therefore updates continuously the lower level which serves as the boundary of the prohibited lower regulating region. This lower level is adjusted so as to have an offset above the minimum degree of engagement. The least possible degree of engagement is detected and is set with an offset to the boundary of the prohibited lower region. A demand for a desired degree of engagement within this region will cause the pump to be directed to full disengagement. If the pump does not come back down to a previous degree of disengagement, the degree of engagement is monitored. When it has stabilised, which indicates that the pump cannot disengage further, the boundary of the prohibited lower region is raised to the prevailing level.

In a further aspect of the present invention, the following regulation may be conducted with a normal regulating strategy within the permissible regulating region:

Should the pump become stuck at full engagement when demand is within the permissible regulating region, the integrating element of the regulation is monitored. If the degree of engagement of the viscoclutch is detected within the prohibited upper region, there is great risk of the viscoclutch becoming stuck. The current integrating element is then saved. If thereafter integrator upswing takes place beyond a maximum limit, the regulator switches off and the whole oil supply is throttled to release the viscoclutch from full engagement. When the viscoclutch is again detected within the regulatable region, regulation by the regulator continues, but with quicker response because of reduced integrator upswing. If the pump is regulated back before the maximum limit for integrator upswing is reached, the logic of the PID regulator is zeroed in this respect.

The present invention affords inter alia the following advantages:

The strategy of first throttling the whole oil supply in order to release the viscoclutch from full engagement not only saves for a specific implementation about 60 seconds of response time but also prevents integrator upswing. Regulating with the first regulating strategy, i.e. monitoring and controlling the degree of engagement so that it is substantially constant, at full engagement, further shortens the disengagement time by about 10 seconds. This results inter alia in better fuel economy.

Applying special regulating strategies (the first and second regulating strategies) of switching off the regulation by the normal regulating strategy in the prohibited upper and lower regulating regions, with integrator monitoring, results in a regulating response time which may be about 60 seconds faster (if the regulator has been affected by integrator upswing). The quicker response time may be crucial in ensuring good cooling performance but does above all make more fuel saving possible.

### BRIEF DESCRIPTION OF DRAWINGS

FIG. 1 is a schematic block diagram illustrating the present invention.

FIG. 2 comprises graphs intended to illustrate the present invention.

FIGS. 3-5 are simplified flowcharts intended to illustrate various embodiments of the present invention.

### DETAILED DESCRIPTION OF PREFERRED EMBODIMENTS OF THE INVENTION

The invention will now be described in more detail with reference to the block diagram in

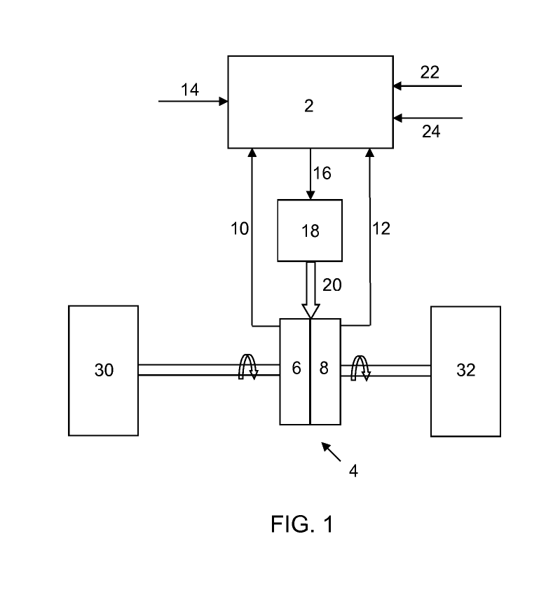

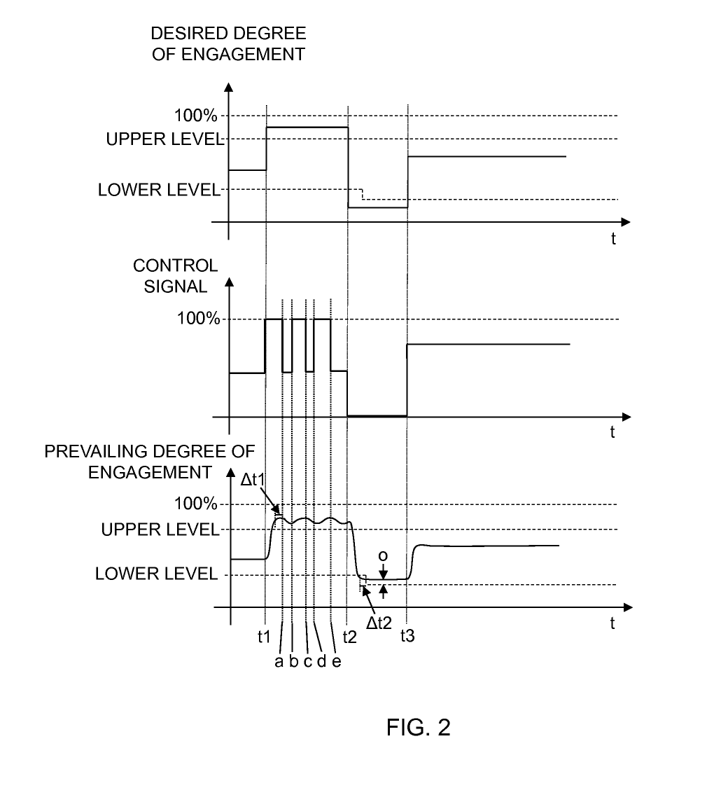

FIG. 1 and to the graphs in FIG. 2, where the top graph shows a desired degree of engagement 14 in percent with respect to time t, the middle graph the control signal 16 in percent to the oil pump unit 18 with respect to time t, and the bottom graph the prevailing measured degree of engagement 15 in percent of the viscoclutch with respect to time t.

The invention thus relates to a regulating device 2 for a viscoclutch 4 of a conventional kind provided with a primary disc 6 and a secondary disc 8.

During operation, the primary disc has a first rotation speed 10 and the secondary disc a second rotation speed 12, and the regulating device 2 is adapted to receiving signals which represent these rotation speeds and a desired degree of engagement 14. The regulating device is adapted to calculating a prevailing degree of engagement 15 between the primary disc and the secondary disc as the ratio between the second rotation speed 12 and the first rotation speed 10. The degree of engagement between the discs is controlled by the regulating device on the basis of a desired degree of engagement 14. This is achieved by regulating the amount of viscous oil between the discs by delivering a control signal 16 to an oil pump unit 18 which is adapted to pumping oil 20 into the viscoclutch in response to the control signal.

If the desired degree of engagement 14 is higher than an adjustable upper level 22, the regulating device is adapted to regulating the engagement of the viscoclutch according to a first regulating strategy. This happens when the regulating device 2 receives a signal for the viscoclutch to be engaged to a desired degree of engagement 14 depicted in the top graph in FIG. 2 at time t1 when the desired degree of engagement is above level 22. This first regulating strategy involves alternately changing the control signal 16 by first generating a control signal to the oil pump unit for maximum engagement. This takes place during the period t1-a, where the control signal is depicted in the middle graph and the measured degree of engagement appears in the bottom graph.

Thereafter, when the degree of engagement has been substantially constant for longer than a predetermined first amount of time (Δt1), the control signal is changed to effect a degree of engagement below said upper level 22 until the degree of engagement is no longer substantially constant. This takes place during the period a-b. This may also be expressed in terms of examining the derivative of the degree of engagement and when the derivative has been substantially zero for a certain first amount of time, the control signal is changed (reduced) until the derivative is no longer substantially zero.

When the degree of engagement is no longer substantially constant, i.e. when its derivative is no longer substantially zero and is therefore decreasing, the control signal 16 to the oil pump unit 18 is changed back to effect maximum engagement at time b. Over the period b-c the control signal 16 is maximum, i.e. with maximum oil being pumped into the viscoclutch. When the degree of engagement has been constant for longer than Δt1 (not depicted in the drawing), the control signal 16 is changed back at time c to effect a degree of engagement below level 22. At time d the control signal 16 is changed back to maximum before reverting to a lower level at time e.

At time t2 the desired engagement level 14 is altered to a lower level.

In one embodiment the degree of engagement is regarded as substantially constant when it varies by not more than 5%.

The first amount of time Δt1 is preferably shorter than 30 seconds, e.g. about 5 seconds, but has to be long enough to make it possible to calculate the degree of engagement.

According to the invention, the oil level in the viscoclutch is thus regulated in such a way as to be just sufficient to reach the desired high engagement level. This results in quicker disengagement in that a smaller amount of oil need be pumped out from the viscoclutch.

In one embodiment, if the desired degree of engagement 14 is instead below an adjustable lower level 24, the regulating device is adapted to regulating the engagement of the viscoclutch according to a second regulating strategy which involves changing the control signal by having the control signal 16 to the oil pump 18 effect minimum engagement (see FIG. 2). This takes place at time t2 and, as the top graph indicates, the desired degree of engagement 14 is here below the lower level 24 and the control signal 16 goes down to a minimum level (middle graph).

The second regulating strategy means that when the degree of engagement has been substantially constant for longer than a predetermined second amount of time (Δt2), this level of the degree of engagement at which it has been constant is determined and the lower level may then be altered to a level which depends on the level determined. The lower level 24 is preferably altered to a level which is below the measured constant degree of engagement by a predetermined offset value. This is marked “o” in the diagram where in the case illustrated the level 24 is altered (lowered) to below the measured constant degree of engagement.

The second amount of time Δt2 is preferably shorter than 30 seconds, e.g. about 5 seconds, but has to be long enough to make it possible to calculate the degree of engagement. The same value may be adopted for Δt2 as for Δt1.

A variant of the second regulating strategy when disengaging from the prohibited upper region is to throttle the whole oil supply to a desired degree of engagement which is within the permissible region.

A further variant moves step by step from full engagement to the permissible region and then to the prohibited lower region.

When the desired degree of engagement is between said upper and lower levels, the regulating device is adapted to regulating the viscoclutch according to a predetermined normal regulating strategy, e.g. with a PI or PID regulator, comprising inter alia an integrating element. This normal regulating strategy will not be described here, since it works in a conventional way.

If the prevailing degree of engagement is above said upper level, with consequent risk of the viscoclutch becoming stuck at full engagement, and a control signal to the oil pump for regulation within the permissible regulating region is generated, the integrating element of the regulation is monitored and in a further embodiment the regulating device is then adapted to storing the current value of the integrating element. If thereafter integrator upswing takes place above a maximum limit, the regulator switches off and the whole oil supply is throttled to release the viscoclutch from full engagement. When the viscoclutch is again detected within the regulatable region, regulation by regulator continues, but with quicker response because of reduced integrator upswing, i.e. the integrating element is reduced. If the pump is regulated back before the maximum limit for integrator upswing is reached, the logic of the regulator is zeroed.

In one embodiment the regulating device is adapted to regulating the degree of engagement of a viscoclutch associated with a coolant pump. The regulating device may of course also be used to regulate a viscoclutch associated with, for example, a fan.

The invention further comprises a vehicle provided with a combustion engine 30 and a coolant pump 32 intended to cool the engine and driven via a viscoclutch 4 which is regulated by a regulating device 2 as described above. The oil pump unit 18 is often an integral part of the viscoclutch.

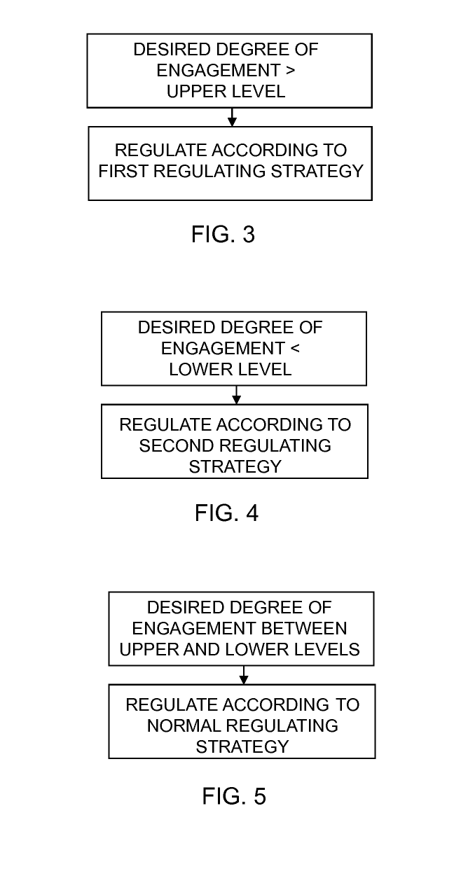

The present invention comprises also a method for regulating a viscoclutch which is provided with a primary disc and a secondary disc, the primary disc having a first rotation speed and the secondary disc a second rotation speed. FIGS. 3-5 are simplified flowcharts intended to illustrate various embodiments of the present invention.

The method comprises
determining a prevailing degree of engagement between the primary and secondary discs, e.g. in the form of the ratio between said second and first rotation speeds,
controlling the degree of engagement between the discs on the basis of a desired degree of engagement by regulating the amount of viscous oil between them by delivering a control signal to an oil pump unit which is adapted to pumping oil into the viscoclutch in response to the control signal.

With reference to FIG. 3, the method according to the invention further comprises
if the desired degree of engagement is higher than an adjustable upper level, regulating the engagement of the viscoclutch according to a first regulating strategy which involves alternately changing the control signal by first generating a control signal to the oil pump unit for maximum engagement and thereafter, when the degree of engagement has been substantially constant for longer than a predetermined first amount of time (Δt1), changing the control signal to effect a degree of engagement below said upper level until the degree of engagement is no longer substantially constant. This embodiment is discussed in more detail above, inter alia with reference to the graphs in FIG. 2.

In a further embodiment of the invention illustrated by the flowchart in FIG. 4, the method comprises, if a desired degree of engagement is below an adjustable lower level, regulating the engagement of the viscoclutch according to a second regulating strategy which involves changing the control signal by having the control signal to the oil pump unit effect minimum engagement. The second regulating strategy also involves, when the degree of engagement has been substantially constant for longer than a predetermined second amount of time (Δt2), determining this level of the degree of engagement at which it has been constant, and altering the lower level to a level which depends on the level determined. Here again, FIG. 2 and the above description should be referred to.

In a further embodiment of the invention, illustrated by the flowchart in FIG. 5, when a desired degree of engagement is between said upper and lower levels, the regulating device is adapted to regulating the viscoclutch according to a predetermined normal regulating strategy comprising inter alia an integrating element.

If the prevailing degree of engagement is then above said upper level, the current value of the integrating element is stored. If thereafter integrator upswing occurs beyond a maximum limit, the regulator switches off and the whole oil supply is throttled to release the viscoclutch from full engagement. When the viscoclutch is again detected within the regulatable region, regulation by regulator continues, but with quicker response because of reduced integrator upswing, i.e. the integrating element is reduced. If the pump is regulated back before the maximum limit of integrator upswing is reached, the logic of the regulator is zeroed.

The method according to the present invention is preferably adapted to regulating the degree of engagement of a viscoclutch associated with a coolant pump.

The present invention is not restricted to the preferred embodiments described above. Sundry alternatives, modifications and equivalents may be used. The above embodiments are therefore not to be regarded as limiting the invention's protective scope which is defined by the attached claims.

1. A regulating device for a viscoclutch wherein the clutch includes a primary disc and a secondary disc opposing the primary disc, the primary disc having a first rotation speed and the secondary disc having a second rotation speed;
the regulating device being configured for receiving signals which represent the rotation speeds and a desired degree of engagement of the primary and secondary discs, and for determining a prevailing degree of engagement between the primary disc and the secondary disc, the regulating device being configured for controlling the degree of engagement between the discs based on a desired degree of engagement by of the discs;
an oil pump unit configured for pumping oil;
the regulating device being configured for regulating an amount of viscous oil between the discs by delivering a control signal to the oil pump unit which is configured for pumping the oil into the viscoclutch in response to the control signal;
when the desired degree of engagement of the discs is higher than a selected upper level, the regulating device is configured for regulating the engagement of the viscoclutch according to a first regulating strategy which includes alternately changing the control signal by first generating a control signal to the oil pump unit for maximum engagement of the discs and thereafter, when the degree of engagement has been substantially constant for longer than a predetermined first amount of time (Δt1), changing the control signal to effect a degree of engagement of the discs below the upper level until the degree of engagement is no longer substantially constant.

2. The regulating device according to claim 1, wherein when the desired degree of engagement is below a lower level, the regulating device is configured for regulating the engagement of the viscoclutch according to a second regulating strategy which involves changing the control signal to cause the control signal to the oil pump unit to effect minimum engagement of the discs.

3. The regulating device according to claim 2, wherein when the degree of engagement has been substantially constant for longer than a predetermined second amount of time (Δt2), the second regulating strategy further comprises determining the level of the degree of engagement at which the degree of engagement has been constant, and altering the lower level to a level which depends on the level determined.

4. The regulating device according to claim 1, wherein the first amount of time (Δt1) is shorter than 30 seconds.

5. The regulating device according to claim 3, wherein the second amount of time (Δt2) is shorter than 30 seconds.

6. The regulating device according to claim 1, wherein the degree of engagement being substantially constant means not varying by more than 5%.

7. The regulating device according to claim 2, wherein when a desired degree of engagement is between the upper level and the lower level, the regulating device is configured for regulating the viscoclutch according to a predetermined normal regulating strategy which comprises an integrating element.

8. The regulating device according to claim 7, wherein when the prevailing degree of engagement of the discs is above the upper level, a current value of the integrating element is stored, a control signal to the oil pump unit for full engagement of the discs is generated and the integrating element of the normal regulating strategy is reduced to below the stored value.

9. The regulating device according to claim 1, further comprising the device being configured for a coolant pump to regulating the degree of engagement of the viscoclutch associated with the coolant pump.

10. A vehicle provided with a combustion engine and a coolant pump connected, configured and operated to cool the engine and the coolant pump is driven via the viscoclutch which is regulated by the regulating device according to claim 1.

11. A method for regulating a viscoclutch which comprises a primary disc and a secondary disc, the primary disc having a first rotation speed and the secondary disc having a second rotation speed;
the method comprising:
determining a prevailing degree of engagement between the primary and the secondary discs;
controlling the degree of engagement between the discs based on a desired degree of engagement by regulating the amount of viscous oil between the discs, by delivering a control signal to an oil pump unit which is configured for pumping oil into the viscoclutch in response to the control signal, wherein when the desired degree of engagement is higher than an upper level, regulating the engagement of the viscoclutch according to a first regulating strategy which involves alternately changing the control signal by first generating a control signal to the oil pump unit for maximum engagement and thereafter, when the degree of engagement has been substantially constant for longer than a predetermined first amount of time (Δt1), changing the control signal to effect a degree of engagement below the upper level until the degree of engagement is no longer substantially constant.

12. The method according to claim 11, wherein when a desired degree of engagement is below a lower level, regulating the engagement of the viscoclutch according to a second regulating strategy which involves changing the control signal to cause the control signal to the oil pump unit to effect minimum engagement.

13. The method according to claim 12, wherein when the degree of engagement has been substantially constant for longer than a predetermined second amount of time (Δt2), the second regulating strategy involves also determining the level of the degree of engagement at which it has been constant, and altering the lower level to a level which depends on the level determined.

14. The method according to claim 11, wherein the first amount of time (Δt1) is shorter than 30 seconds.

15. The method according to claim 13, said wherein the second amount of time (Δt2) is shorter than 30 seconds.

16. The method according to claim 11, wherein substantially constant means that the degree of engagement varies by not more than 5%.

17. The method according to claim 12, wherein when a desired degree of engagement is between the upper level and the lower level, the method comprises regulating the viscoclutch according to a predetermined normal regulating strategy which comprises an integrating element.

18. The method according to claim 17, wherein if the prevailing degree of engagement is above the upper level, the method comprises storing the current value of the integrating element, generating a control signal to the oil pump unit for full engagement of the discs and reducing the integrating element of the normal regulating strategy to a value below the stored value.

19. The method according to claim according to claim 11, configured for regulating the degree of engagement of a viscoclutch associated with a coolant pump.
